(19) United States
(12) Patent Application Publication
(10) Pub. No.: US 2016/0171018 A1
(43) Pub. Date: Jun. 16, 2016

(54) APPEND STRUCTURED DATA SYSTEM FOR MAINTAINING STRUCTURED FORMAT COMPATIBILITY

(71) Applicant: Microsoft Technology Licensing, LLC, Redmond, WA (US)

(72) Inventors: Sergey Baranchenkov, Redmond, WA (US); Anastasia Baranchenkova, Redmond, WA (US)

(21) Appl. No.: 14/572,695

(22) Filed: Dec. 16, 2014

(51) Int. Cl. G06F 17/30

(52) U.S. Cl. CPC G06F 17/30289; G06F 17/30607; G06F 17/30345

(57) ABSTRACT

An append structured data system maintains a data collection (e.g., a log file) in a structured format (e.g., a JSON-compatible format). The system receives (e.g., from a web server) new data to be written to the data collection file. The system creates a structured object (e.g., a JSON object) from the new data (e.g., describing an alarm condition). The system also determines whether the data collection contains existing data. When the data collection does not contain existing data (e.g., is empty), the system writes the structured object within an enclosing structure (e.g., a JSON array) of the structured format. When the data collection does contain existing data, the system replaces a terminal portion of the data collection (e.g., a right square bracket) with data that includes the structured object and format compatibility data (e.g., a comma separating array elements and right square bracket).

### BACKGROUND

Many types of programs output to a log file data describing current conditions of the program. For example, upon detecting an alarm condition, a web server may append to a log file data describing the alarm and provide to a user an HTML document with a link to the log file. The data written to the log file may be text in the form of attribute/value pairs, and the log file may be in a text format (e.g., a .txt file). As another example, a communications driver for a communications channel may record in a log file a history of the communications of the channel. Each time a communication is received or transmitted, the communications driver may record information such as the names of the sender and recipient, the time of the communication, the size of the communication, and so on. This recorded information may also be stored as attribute/value pairs.

The tracking of the conditions of a program can be useful for many reasons. For example, an alarm may be raised by a web server when a broken link is encountered. In such a case, the web server may write to the log file data that includes the URL of the broken link, the URL of the web page that contains the broken link, the time of access, and so on. An administrator can review the log file and take actions to repair or remove the broken link. As another example, a web server may write to a log file summaries of user sessions. The summaries may include an identifier of a user, start and end time of the session, the web pages accessed during the session, and so on. These summaries can be used to analyze user interactions with a web site to improve performance of the web site, such as by combining web pages that are frequently accessed together. As another example, the information recorded by a communications driver can be analyzed to identify communications patterns, identify users who use the communications frequently, determine when to increase the capacity of the communications channel, and so on.

Typically, log files are written as simple text files so that they can be accessed using conventional word processing programs, print programs, text editors, and so on. Although such log files can be accessed by readily available programs, such programs typically do not understand the underlying structure of the data in the log file. Without such an understanding, these programs cannot, for example, separate data out based on individual web or communication sessions. Although special-purpose access programs can be developed for parsing through the log files, the cost of initial development and ongoing maintenance of such special-purpose access programs can be high.

### BRIEF DESCRIPTION OF THE DRAWINGS

FIG. 1 is a block diagram that illustrates components related to an append structured data system in some embodiments.

FIG. 2 is a flow diagram that illustrates the processing of an append new data component in some embodiments.

FIG. 3 is a flow diagram that illustrates the processing of a write to data collection component in some embodiments.

FIG. 4 is a flow diagram that illustrates the processing of a write to log file component in some embodiments.

### DETAILED DESCRIPTION

A method and system for appending data to existing data of a data collection in a way that is compatible with a structured data format is provided. In some embodiments, an append structured data system maintains data of a data collection so that the data is compatible with a structured data format while reducing the need to rewrite data previously written to the data collection. The append structured data system stores the data of the data collection in a standardized structured data format so that conventional readers or viewers developed to access the structured data format can be used to access the data. One such structured data format is the JavaScript Object Notation (“JSON”) as defined by the European Computer Manufacturer's Association (“ECMA”) as ECMA-404 or as defined by the Internet Engineering Task Force (“IETF”) as RFC-7159. The ECMA-404 and the RFC-7159 are both hereby incorporated by reference. JSON defines the grammar of a JSON value. A JSON value can be a JSON array, a JSON object, a JSON number, a JSON string, and a JSON literal (e.g., “null”). A JSON array contains an ordered list of elements that are JSON values. A JSON object contains a list of string:value pairs. JSON arrays and objects can be nested within JSON arrays and objects to define a hierarchical organization of the data. Many JSON readers and viewers have been developed that understand the structure of the data of a JSON file and can provide structured access to the data, such as via an application programming interface or a program that displays the data factoring in the structured data format. For example, a JSON application programming interface can provide methods to retrieve the next element of a JSON array, the next string:value pair of a JSON object, and so on. A JSON viewer can display elements of JSON data, factoring in the hierarchical structure of the data, such as a JSON array with JSON objects as elements of the array with string:value pairs as data of the JSON objects.

To take advantage of the existing readers and viewers for a standard structured data format, such as JSON, without rewriting (or at least minimizing the re-writing of) data already in the data collection, the append structured data system first receives new data to be written to a data collection of existing data. For example, the new data may be attribute-value pairs to be written to a log file by a program such as a web server or a communications driver. The append structured data system creates a structured object (e.g., a JSON object) that encodes the output data as string:value pairs. For example, if the new data is:

Sender=Smith

Recipient=Jones

Time=Jan. 1, 2015

Size=1024

the append structured data may create the following JSON object:

{“Sender”:“Smith”,

“Recipient”:“Jones”,
“Time”:“Jan 1, 2015”,
“Size”:1024}

The left (“{”) and right (“}”) curly brackets are beginning and ending delimiters of the JSON object. The new data could be appended to the existing data by writing another JSON object after the last JSON object in the data collection as follows:

{“Sender”:“Smith”,

“Recipient”:“Jones”,
“Time”:“Jan 1, 2015”,
“Size”:1024}

{“Sender”:“Jones”,

“Recipient”:“Smith”,
“Time”:“Jan 2, 2015”,
“Size”:512}

However, such data would not be in a JSON-compatible format. To maintain a JSON compatible format, the append structured data system, in some embodiments, stores the JSON objects as elements of a JSON array. When initially writing the first JSON object to the data collection, the append structured data system writes the JSON object as an element within a JSON array as follows:

[{“Sender”:“Smith”,

“Recipient”:“Jones”,
“Time”:“Jan 1, 2015”,
“Size”:1024}]

The left (“[”) and (“]”) right square brackets are the beginning and ending delimiters of a JSON array. New data, however, cannot be simply added to the end of JSON-compatible data and still be JSON-compatible. To maintain JSON compatibility, the existing data could be retrieved and the existing data and the new data could be written to the data collection in a way that maintains JSON compatibility. Such an approach to rewriting a data collection to maintain JSON compatibility can be a very time-consuming and computationally expensive process because the existing content of the data collection can include thousands of JSON objects, each with tens of string:value pairs. In addition, during the rewriting process the data could not be accessed by a JSON reader because the data would not be JSON-compatible until the rewriting is complete.

The append structured data system avoids such a need to read and rewrite existing data by replacing a terminal portion of the data collection with the new data and format compatibility data to maintain JSON compatibility. For example, to add a new JSON object as an element of a JSON array, the append structured data system replaces the ending delimiter of the JSON array with an element delimiter (e.g., a comma), the new JSON object, and an ending delimiter of the JSON array. So, in the example above, the adding of the second JSON object would result in the following JSON-compatible data collection:

[{“Sender”:“Smith”,

“Recipient”:“Jones”,
“Time”:“Jan 1, 2015”,
“Size”:1024},

{“Sender”:“Jones”,

“Recipient”:“Smith”,
“Time”:“Jan 2, 2015”,
“Size”:512}]

Because the content will not be JSON-compatible during the replacing process, the append structured data system may perform the replacing using an atomic operation, while the data collection is locked, or using some other mechanism to ensure that another program (e.g., JSON reader) does not access the data while it is not JSON-compatible.

In some embodiments, the append structured data system may output to a JSON-compatible file new data that is serialized data of an object to a programming language such as JAVA, C++, or C#. The append structured data system may encode the serialized name/value pairs representing data members of an object as string:value pairs of a JSON object. The append structured data system may be adapted to also encode the object type into the data that is written to the data collections so that the data can be de-serialized into an object of the encoded object type without prior knowledge of the object type. To encode the object type, the append structured data system may nest a JSON object containing string:value pairs representing the data members of the object within a JSON object that contains a string:value pair with the string encoding the object type and the value being the JSON object representing the data member. For example, if the JSON objects of the JSON array represent serialization of objects of the types of RECEIVING and SENDING, then the append structured data system may represent the content as:

[{“RECEIVING”:{“Sender”:“Smith”,

“Recipient”:“Jones”,
“Time”:“Jan 1, 2015”,
“Size”:1024}},

{“SENDING”:{“Sender”:“Jones”,

“Recipient”:“Smith”,
“Time”:“Jan 2, 2015”,
“Size”:512}}]

The append structured data system could alternatively encode each of the serialized object data and the object type as string:value pairs of an enclosing object as follows:

[{“type”:“RECEIVING”,

“data”:{“Sender”:“Smith”,

```
  “Recipient”:“Jones”,
  “Time”:“Jan 1, 2015”,
  “Size”:1024}},
```

{“type”:“SENDING”,

“data”:{“Sender”:“Jones”,

“Recipient”:“Smith”,
“Time”:“Jan 2, 2015”,
“Size”:512}}]

Since JSON allows data to be nested not only in JSON arrays but also in JSON objects, the append structured data system can encode JSON objects containing the data of the data collection as values of string:value pairs of an enclosing JSON object. Therefore, the data of the two JSON objects can also be encoded as follows:

{“1”:{“Sender”:“Smith”,

“Recipient”:“Jones”,
“Time”:“Jan 1, 2015”,
“Size”:1024},

“2”:{“Sender”:“Jones”,

“Recipient”:“Smith”,
“Time”:“Jan 2, 2015”,
“Size”:512}}

To add new data to such an encoding, the append structured data system would replace the right curly bracket at the end with another element of the enclosing JSON object as follows:

{“1”:{“Sender”:“Smith”,

“Recipient”:“Jones”,
“Time”:“Jan 1, 2015”,
“Size”:1024},

“2”:{“Sender”:“Jones”,

“Recipient”:“Smith”,
“Time”:“Jan 2, 2015”,
“Size”:512},

“3”:{“Sender”:“Franks”,

“Recipient”:“Smith”,
“Time”:“Jan 2, 2015”,
“Size”:2048}}

The append structured data system replaces the right curly bracket at the end with a comma, the new data encoded as the value in another string:value pair of the enclosing JSON object, and another right curly bracket at the end.

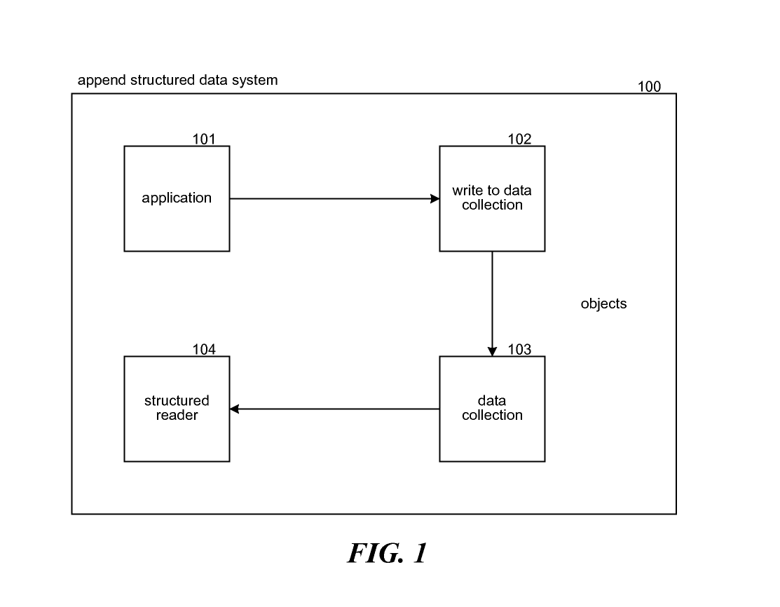

FIG. 1 is a block diagram that illustrates components related to an append structured data system in some embodiments. The append structured data system 100 allows new data to be written to a structured collection of existing data without the need to rewrite the existing data. When an application program 101 generates new data; for example, a web server may generate new data describing a new alarm condition, the application provides the new data to a write to data collection component 102. The write to data collection component writes the new data to a data collection 103 to maintain compatibility with the structured data format. To maintain compatibility, the write to data collection component replaces a terminal portion of the data collection with structured data that encodes the new data along with format compatibility data to ensure the data collection is compatible with the structured data format. A structured reader 104, such as a JSON reader, can access the entire data collection except while the write to data collection component is writing the new data and the format compatibility data to the data collection.

The computing devices and systems on which the append structured data system may be implemented may include a central processing unit, input devices, output devices (e.g., display devices and speakers), storage devices (e.g., memory and disk drives), network interfaces, graphics processing units, accelerometers, cellular radio link interfaces, global positioning system devices, and so on. The input devices may include keyboards, pointing devices, touch screens, gesture recognition devices (e.g., for air gestures), head and eye tracking devices, microphones for voice recognition, and so on. The computing devices may include desktop computers, laptops, tablets, e-readers, personal digital assistants, smartphones, gaming devices, servers, and computer systems such as massively parallel systems. The computing devices may access computer-readable media that include computer-readable storage media and data transmission media. The computer-readable storage media are tangible storage means that do not include a transitory, propagating signal. Examples of computer-readable storage media include memory such as primary memory, cache memory, and secondary memory (e.g., DVD) and include other storage means. The computer-readable storage media may have recorded upon or may be encoded with computer-executable instructions or logic that implements the append structured data system. The data transmission media is used for transmitting data via transitory, propagating signals or carrier waves (e.g., electromagnetism) via a wired or wireless connection.

The append structured data system is described in the general context of computer-executable instructions, such as program modules and components, executed by one or more computers, processors, or other devices. Generally, program modules or components include routines, programs, objects, data structures, and so on that perform particular tasks or implement particular data types. Typically, the functionality of the program modules may be combined or distributed as desired in various embodiments. Aspects of the append structured data system may be implemented in hardware using, for example, an application-specific integrated circuit (“ASIC”).

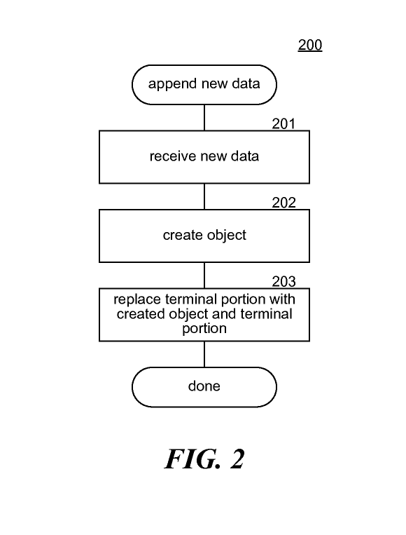

FIG. 2 is a flow diagram that illustrates the processing of an append new data component in some embodiments. The append new data component 200 is an implementation of the write to data collection component 102. The component writes data to the data collection in a way that maintains compatibility with a structured format. In block 201, the component receives the new data from a program such as a web server or a communications driver. In block 202, the component creates an object as defined by the structured data format. The created object encodes the new data. In block 203, the component replaces a terminal portion of the data collection with the created object and format compatibility data. To prevent access to the portion of the data collection that is replacing the terminal portion, the component may perform the replacing as an atomic operation or may lock and unlock a portion of or the entire data collection during the replacing. The component then completes.

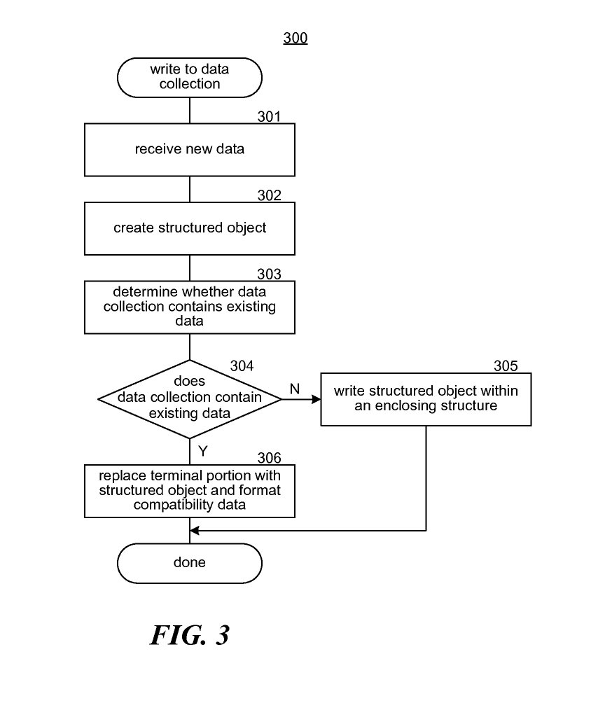

FIG. 3 is a flow diagram that illustrates the processing of a write to data collection component in some embodiments. The write to data collection component 300 is invoked to write new data to a data collection. In block 301, the component receives the new data. In block 302, the component creates a structured object, such as a JSON object, that encodes the new data. In block 303, the component determines whether the data collection contains existing data. In decision block 304, if the data collection contains existing data, then the component continues at block 306, else the component continues at block 305. In block 305, the component writes the structured object within an enclosing structure to the data collection. In some embodiments, the structured object is a JSON object. The component then completes. In block 306, the component replaces the terminal portion of the data collection with the structured object and format compatibility data. In some embodiments, if the enclosing structure is a JSON array, the terminal portion is a right square bracket terminating a JSON array, and the format compatibility data is a comma that separates elements of the JSON array and a right square bracket terminating the JSON array. In other embodiments, if the enclosing structure is a JSON object, the terminal portion is a right curly bracket terminating the enclosing JSON object and the format compatibility data is a comma that separates string:value pairs of the enclosing JSON object and a right curly bracket terminating the enclosing JSON object. In some embodiments, if multiple enclosing structures enclose the JSON objects that encode the new data, such as when the JSON objects are elements of a JSON array that is itself an element of a JSON array, then the terminal portion is the two right square brackets.

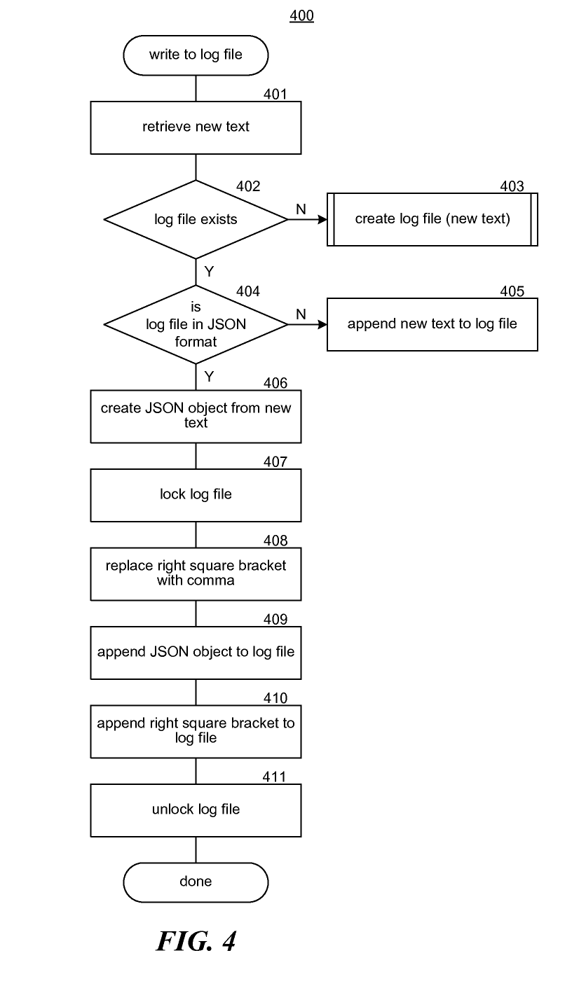

FIG. 4 is a flow diagram that illustrates the processing of a write to log file component in some embodiments. The write to log file component 400 writes new text data to a log file that is either in a text format or a JSON format. If the log file does not currently exist, the component creates the log file. In block 401, the component retrieves the new text data. In decision block 402, if the log file exists, then the component continues at block 404, else the component continues at block 403. In block 403, the component invokes a create log file passing the new text data to create the new log file that contains the new data and then completes. In decision block 404, if the log file is in the JSON format, then the component continues at block 406, else the component continues at block 405. In block 405, the component appends the new text data to the log file and then completes. In block 406, the component creates a JSON object from the new text data. In block 407, the component locks the log file or at least a portion of the log file to prevent access by a reader while the log file is not in a JSON-compatible format. In block 408, the component replaces the right square bracket at the end of the log file with a comma that separates the elements of a JSON array. In block 409, the component appends the JSON object to the log file. In block 410, the component appends a right square bracket to the log file, which places the log file in a JSON-compatible format. In block 411, the component unlocks the log file and then completes.

In some embodiments, the append structured data system implements a method that is performed by a computing device for maintaining a data collection (e.g., a log file) in a structured format (e.g., a JSON-compatible format). The method receives (e.g., from a web server) new data to be written to the data collection file. The method creates a structured object (e.g., a JSON object) from the new data (e.g., describing an alarm condition). The method also determines whether the data collection contains existing data. When the data collection does not contain existing data (e.g., is empty), the method writes the structured object within an enclosing structure (e.g., a JSON array) of the structured format. When the data collection does contain existing data, the method replaces a terminal portion of the data collection (e.g., a right square bracket) with data that includes the structured object and format compatibility data (e.g., a comma separating array elements and right square bracket). The structured format may be a JSON-compatible format. The terminal portion may be a right enclosure of a JSON array of JSON objects. The terminal portion may be a right enclosure of a JSON object that contains one or more string:value pairs with the structured object being a JSON object that is a value of a string:value pair. The structured object may a JSON object within a JSON array of JSON objects. The structure object may be a JSON object that is a value of a string:value pair of a JSON object. The method may further lock the data collection while replacing the terminal portion. The structured object may include an indication of an object type that the new data represents.

In some embodiments, the append structured data system may be implemented via a computing device that maintains a JSON-compatible file. The computing device comprises a computer-readable storage medium that stores computer-executable instructions for controlling the computing device to receive new data to be appended to the JSON-compatible file, create a JSON structure that encodes the new data, and replace a terminal portion of an enclosing JSON structure with the created JSON structure and JSON compatibility data to ensure the enclosing JSON structure is JSON-compatible. The computing device further comprises a processor for executing the computer-executable instructions stored by the computer-readable storage medium. The enclosing JSON structure may be a JSON array. The created JSON structure is a JSON object. The JSON compatibility data may be a comma to separate elements of the JSON array and a right square bracket to terminate the JSON array. The terminal portion may be a right square bracket of the JSON array. The computer-executable instructions may further comprise instructions to create a JSON-compatible file with the enclosing JSON structure that encloses the JSON structure that encodes the new data. The replacing of the terminal portion may be performed as an atomic operation.

In some embodiments, a computer-readable storage medium stores computer-executable instructions for controlling a computing device to maintain a data collection that is compatible with a structured data interchange format. The data collection is maintained as a structured array. The instructions comprise instructions of a module that receives new data to be appended to the data collection, a module that creates a structured object that encodes the new data as name/value pairs, and a module that replaces a terminal portion of the structured array with data that includes the structured object and format compatibility data of the structured array. The structured data interchange format may be compatible with JSON. The structured array may be a JSON array and the structured object may be a JSON object and wherein the instructions further comprise instructions of a module that creates a data collection as the JSON array with a JSON object as an element that encodes initial new data. The new data may be a serialization of data members of an object having an object type and the structured object may be a JSON object that encodes the data members and the object type. The object type may be represented by a string:value pair of a JSON object with the value indicating the object type, and the new data may be represented by another string:value pair of the JSON object with the value being a JSON object that encodes the new data.

Although the subject matter has been described in language specific to structural features and/or acts, it is to be understood that the subject matter defined in the appended claims is not necessarily limited to the specific features or acts described above. Rather, the specific features and acts described above are disclosed as example forms of implementing the claims. For example, the replacing of the terminal portion of a data collection can, in some embodiments, include rewriting some portions of the existing data such as the last structured object written to the data collection. Accordingly, the invention is not limited except as by the appended claims.

1. A method performed by a computing device for maintaining a data collection in a structured format, the method comprising:
receiving new data to be written to the data collection file;
creating a structured object from the new data;
determining whether the data collection contains existing data;
when the data collection does not contain existing data, writing the structured object within an enclosing structure of the structured format; and
when the data collection does contain existing data, replacing a terminal portion of the data collection with data that includes the structured object and format compatibility data.

2. The method of claim 1 wherein the structured format is a JSON-compatible format.

3. The method of claim 1 wherein the terminal portion is a right enclosure of a JSON array of JSON objects.

4. The method of claim 1 wherein the terminal portion is a right enclosure of a JSON object that contains one or more string:value pairs with the structured object being a JSON object that is a value of a string:value pair.

5. The method of claim 1 wherein the structured object is a JSON object within a JSON array of JSON objects.

6. The method of claim 1 wherein the structured object is a JSON object that is a value of a string:value pair of a JSON object.

7. The method of claim 1 including locking the data collection while replacing the terminal portion.

8. The method of claim 1 wherein the structured object may include an indication of an object type that the new data represents.

9. A computing device for maintaining a JSON-compatible file, the computing device comprising:
a computer-readable storage medium storing computer-executable instructions for controlling the computing device to:
receive new data to be appended to the JSON-compatible file;
create a JSON structure that encodes the new data; and
replace a terminal portion of an enclosing JSON structure with the created JSON structure and JSON compatibility data to ensure that the enclosing JSON structure is JSON-compatible; and
a processor for executing the computer-executable instructions stored by the computer-readable storage medium.

10. The computing device of claim 9 wherein the enclosing JSON structure is a JSON array.

11. The computing device of claim 10 wherein the created JSON structure is a JSON object.

12. The computing device of claim 11 wherein the JSON compatibility data is a comma to separate elements of the JSON array and a right square bracket to terminate the JSON array.

13. The computing device of claim 12 wherein the terminal portion is a right square bracket of the JSON array.

14. The computing device of claim 9 wherein the computer-executable instructions include instructions to create a JSON-compatible file within the enclosing JSON structure that encloses the JSON structure that encodes the new data.

15. The computing device of claim 9 wherein the replacing of the terminal portion is performed as an atomic operation.

16. A computer-readable storage medium storing computer-executable instructions for controlling a computing device to maintain a data collection that is compatible with a structured data interchange format, the data collection maintained as a structured array, the instructions comprising instructions that:
receive new data to be appended to the data collection;
create a structured object that encodes the new data as name/value pairs; and
replace a terminal portion of the structured array with data that includes the structured object and format compatibility data of the structured array.

17. The computer-readable storage medium of claim 16 wherein the structured data interchange format is compatible with JSON.

18. The computer-readable storage medium of claim 17 wherein the structured array is a JSON array and the structured object is a JSON object and wherein the instructions further include instructions that create a data collection as the JSON array with a JSON object as an element that encodes initial new data.

19. The computer-readable storage medium of claim 17 wherein the new data is a serialization of data members of an object having an object type and the structured object is a JSON object that encodes the data members and the object type.

20. The computer-readable storage medium of claim 19 wherein the object type is represented by a string:value pair of a JSON object with the value indicating the object type and the new data is represented by another string:value pair of the JSON object with the value being a JSON object that encodes the new data.
